(19) United States
(12) Patent Application Publication
(10) Pub. No.: US 2026/0087002 A1
(43) Pub. Date: Mar. 26, 2026

(54) NATURAL LANGUAGE GENERATION FOR DATABASE QUERIES

(71) Applicant: THE TORONTO-DOMINION BANK, TORONTO (CA)

(72) Inventors: Ilan Gofman, TORONTO (CA); Satya Krishna Gorti, TORONTO (CA); Guangwei Yu, TORONTO (CA); Jesse Cole Cresswell, TORONTO (CA); Zhaoyan Liu, TORONTO (CA); Rasa Hosseinzadeh, TORONTO (CA); Jiapeng Wu, TORONTO (CA); Noel Vouitsis, Markham (CA); Maksims Volkovs, TORONTO (CA)

(21) Appl. No.: 19/334,315

(22) Filed: Sep. 19, 2025

Related U.S. Application Data
(60) Provisional application No. 63/698,782, filed on Sep. 25, 2024.

(51) Int. Cl. G06F 16/242; G06F 16/22

(52) U.S. Cl. CPC G06F 16/243; G06F 16/2237

(57) ABSTRACT

A natural language query is translated to a corresponding database query using a language model. To improve the quality of the generated database query, natural language models may be applied to select appropriate tables of the database and to generate a plurality of candidate database queries. Each candidate database query is executed against the database to obtain associated query results. A language model evaluates the plurality of candidate database queries and associated query results to determine which database query most correctly matches the natural language query and returns that database query or associated query results as a response to the natural language query.

### CROSS-REFERENCE TO RELATED APPLICATION

This application claims the benefit of U.S. Provisional Application No. 63/698,782, filed on Sep. 25, 2024, the contents of which is hereby incorporated by reference in its entirety.

### BACKGROUND

This disclosure relates generally to natural language database queries and more particularly to improving efficient performance of language models in generating effective database queries with multi-query evaluation.

Text-to-SQL generation is a rapidly growing area of natural language processing with significant real-world applications. It enables non-expert users to interact with databases using natural language queries, which are then automatically translated into data queries for structured data sets (e.g., SQL queries). This capability is widely applicable across various domains, including business intelligence, customer service automation, and data analysis. For example, it facilitates automating the feature selection process in tabular data prediction tasks which often involves complex aggregation queries over event histories.

Many solutions for generating data queries from natural language may use closed-source models or models that are increasingly expensive to process (e.g., with processing and/or memory requirements). For example, many closed-source models may have a significantly larger number of parameters than smaller open-source models that are readily available to most deployments. Further, approaches that decompose complex tasks into sub-tasks may require a large number of language model calls, significantly increasing the cost of using these approaches. This highlights the importance of developing smaller, task-specific models that maintain accuracy while being computationally efficient.

### SUMMARY

To improve the effectiveness of database queries generated from language model processing of natural language queries, multiple candidate database queries are generated for the natural language query. This approach samples multiple candidate database queries and provides an approach for applying a language model to evaluate multiple candidate database queries to select an optimal database query for a particular natural language query.

This approach may thus sample multiple data queries (e.g., SQL queries) and compare the results with a query evaluation language model. The query evaluation language model may be trained to simultaneously consider multiple candidate database queries, their corresponding execution results, and associated metadata to determine which of the generated SQL queries (and/or associated execution results) should be returned as a response to the natural language query. This approach may use comparatively small language models, such that, although the language models are applied several times (e.g., to obtain multiple candidate database queries), the overall execution time and other resource usage may be significantly smaller than larger models that obtain similar results.

### BRIEF DESCRIPTION OF THE DRAWINGS

FIG. 1 illustrates an example natural language query system, according to one or more embodiments.

FIG. 2 shows an example process for generating an effective database query from a natural language query, according to one or more embodiments.

FIG. 3 shows an example dataflow for generating a candidate database query, according to one or more embodiments.

FIG. 4 shows an example query generation prompt and related candidate database query, according to one or more embodiments.

FIG. 5 shows an example dataflow for evaluating the candidate database queries, according to one or more embodiments.

FIGS. 6A-B shows an example query evaluation prompt and associated response for candidate database query evaluation by a language model, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

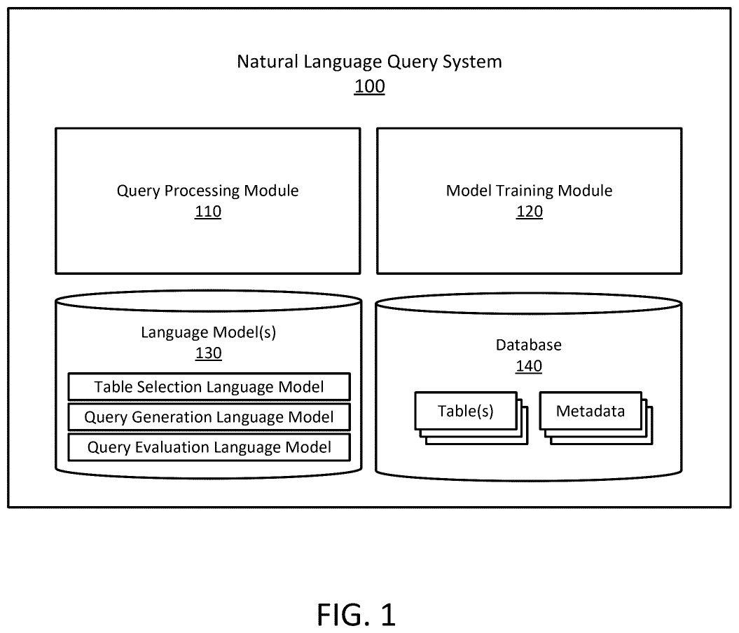

FIG. 1 illustrates an example natural language query system 100, according to one or more embodiments. In general, the natural language query system 100 receives a natural language query that describes a desired query to be performed on a database 140 and determines a database query that corresponds to the natural language query. The database 140 is a structured database that may include a number of tables along with various metadata describing the tables. Each table may include, for example, data entries (e.g., rows) having a number of data fields (e.g., columns) describing structured data that may be retrieved using a structured database query language. Each database 140 may describe its tables according to a schema that describes the data fields, relationships (e.g., between tables), and valid entries for the data fields. For example, the schema may indicate the type of data (e.g., string, Boolean, integer, float, date) that may be stored for a data entry in a particular table. The database 140 may also be associated with various metadata that may provide further information or description of the various tables and/or table contents beyond the structured/defined information of the table schemas. The metadata may describe, for example, further information about database structure, definitions, field/column definitions, data entry definitions, example field entries, and so forth that may vary in various embodiments.

In various embodiments, the database 140 is a Structured Query Language (SQL) database and corresponding database queries may be SQL queries. While SQL is used herein as an example type of database 140 with corresponding queries, other types of suitable databases and corresponding queries may be used in varying embodiments. Though the database 140 is shown as a component of the natural language query system 100, in many embodiments, a separate database management system maintains the database 140 that is accessible to the natural language query system 100. The database 140 along with various computing modules may thus be dispersed at other computing systems in various embodiments.

Text-to-SQL generation involves translating a natural language query q into a database query s that retrieves the desired information from a database. More formally, given a natural language query q, the schema S of a relational database D, and any extra metadata M associated with the query such as extra evidence or few-shot examples from the database, natural language query system generates a valid database query s such that the execution of s on D returns the correct answer to q. This problem is challenging on many fronts because of the diversity in which the natural language question can be expressed, the difficulty in inferring complex relational structures from a database schema, and the restriction of generating only valid SQL syntax.

A query processing module 110 receives a natural language query that describes the desired database query in natural language, such as normal text in a language, such as English. While the natural language query may semantically describe the desired query, the natural language query is not in a compatible format for execution against the database 140. To obtain a corresponding database query for the natural language query, the query processing module 110 may apply one or more language models 130 as discussed further below.

The natural language query may be received from another system, such as a device operated by a user or an agentic system or other computing device that generates queries in a natural language. After determining the corresponding database query, the database query and/or associated results from executing the database query on the database 140 may be returned to the requesting device by the query processing module 110 as a response to the natural language query.

The query processing module 110 may process the natural language query using a set of language models 130, which may include a table selection language model (also termed a “selection model”), query generation language model (also termed a “generation model”), and a query evaluation language model (also termed a “evaluation model”). The language model 130 may be any suitable language model architecture, such as a “large” language model (LLM) or Transformer-based model that may include attention layers, token encoding and decoding, positional encoding, and so forth. Language models 130 may be referred to as “large” language models due to the large number of model parameters for the various layers of the model's operation. In many cases, the language model may include millions and in some cases billions of model parameters for processing language inputs. In general, the language model 130 is configured to receive a sequence of natural language tokens and generate an output sequence of natural language tokens. Additional types of language model architectures may also be used in additional embodiments. The sequence of data provided to the natural language model as an input may also be referred to as a “prompt” and may be composed of several types of data along with additional description to direct the language model in generating an appropriate output. For example, as discussed further below, in one embodiment the query generation language model may receive a prompt that includes the language query, selected database tables (e.g., schema describing the selected tables), and additional metadata relating to the tables.

In some embodiments, the language model 130 may be a general-purpose language model that may be queried with language model inputs (e.g., prompts) for obtaining respective responses. The general-purpose language models 130 may be trained with various textual content of various types, such as books, articles, question-and-answer forums, and so forth. In some embodiments, the language models 130 may include language models trained (e.g., fine-tuned) for the respective tasks as discussed herein.

For example, a model training module 120 may fine-tune a general-purpose language model that has been pre-trained on various textual content. The model training module 120 may fine-tune the general-purpose language model according to the respective language model prompts used by various steps of the query processing module 110 in conjunction with respective training data (not shown). Additional details of the model training for the language models 130 are further discussed below.

### Query Processing Overview

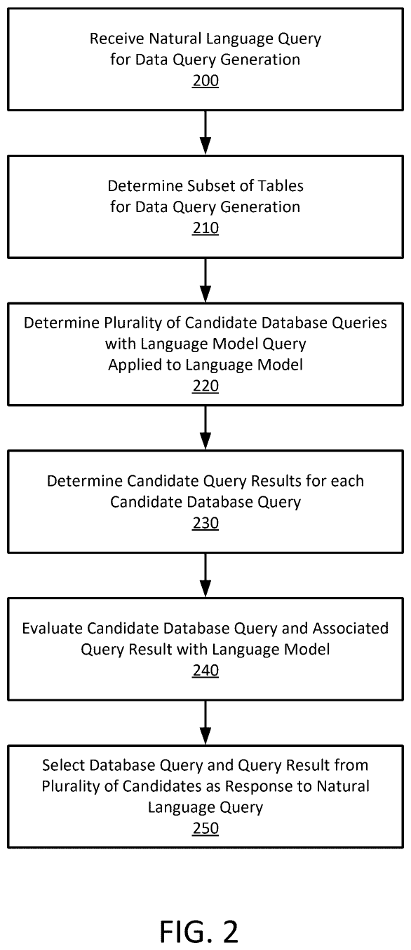

FIG. 2 shows an example process for generating an effective database query from a natural language query, according to one or more embodiments. This process may be performed, for example, by a query processing module 110 as discussed above. However, although shown and described here as a sequence that is performed by one module of a computing system, in various embodiments the different processing steps may be performed by various different computing systems and across different computing modules.

Initially, the query processing module 110 receives 200 a natural language query for generating a corresponding data query. As a general outline, rather than generate a single data query, the process generates a plurality of candidate database queries and uses the evaluation model to evaluate which of the plurality of candidate database queries should be selected as a response to the natural language query.

Initially, the natural language query is used with the table selection language model to determine 210 a subset of tables to be used for data query generation. The selection of tables for the data query generation may also be termed “schema linking.” The table determination 210 determines the relevant tables and attributes within the schema S that are necessary to construct a valid data query based on the natural language query q. For example, deployed databases may include hundreds or thousands of different tables, which may include different schemas and may include various keys for determining relationships and lookups between different tables. Typically, however, data queries only involve a subset of the available tables and attributes. Correctly identifying these tables ensures that the subsequent steps, including data query generation, are focused on the most pertinent tables in the database. Schema linking also reduces the input's length to help it fit in the limited context size of existing language models, while reducing processing and memory costs of processing steps, particularly those that may quadratically increase with input length (e.g., for language models having quadratically scaling attention mechanisms), and improving the likelihood the query generation language model will use appropriate tables for generating the query.

As one example for selecting the relevant tables, a prompt may be generated for a table selection language model for determining the relevant tables (and associated schema) relevant to the natural language query. The table selection may be performed by any suitable means; while a table selection language model is one example, other methods for determining selected table schemas may be performed in additional embodiments.

To determine the relevant tables, the query generation module generates a prompt for the table selection language model. The prompt for the table selection language model may include the natural language query, the schema (for the overall database), and in some embodiments may include additional metadata. Thus, given the schema S containing information about each table and column type including the primary key and foreign key relationships, and corresponding metadata, the table selection language model may generate S_{q}⊆S where S_{q} represents only the schemas of the tables that are predicted to be needed for answering the natural language query q. The metadata may include, for example, additional description or interpretation of the table schema or stored data.

The table selection language model may be trained to optimize recall of tables relevant to a query, such that the table selection language model may over-include tables in its output. As such, the table selection language model may be trained without substantial penalty for false positives (i.e., including tables that are not part of a language) while ensuring that the table selection language model narrows the total number of tables. Because erroneously excluding a table precludes the data query generation from including a necessary table, this over-inclusion aims to ensure that all necessary tables are included in the selected tables.

Using the determined 210 tables and associated schemas, a query generation language model determines 220 a plurality of candidate database queries. That is, rather than generate a single data query, multiple candidate database queries are generated that may subsequently be evaluated 240 by the query evaluation language model. The different candidate database queries may be determined (e.g., generated) in various ways in different embodiments. In some embodiments, different data queries may be generated by querying the generation model multiple times. For example, language models may often include stochastic elements, such that the outputs of the language model include some potential for variation. By sampling the same model several times, multiple outputs can be determined and then evaluated. In additional embodiments, the candidate database queries may be generated by different language models. For example, different query generation language models may include language models that were separately trained with different initialized values (e.g., different seeds), with different general-purpose training data, or with different architectures.

### Generating Database Queries

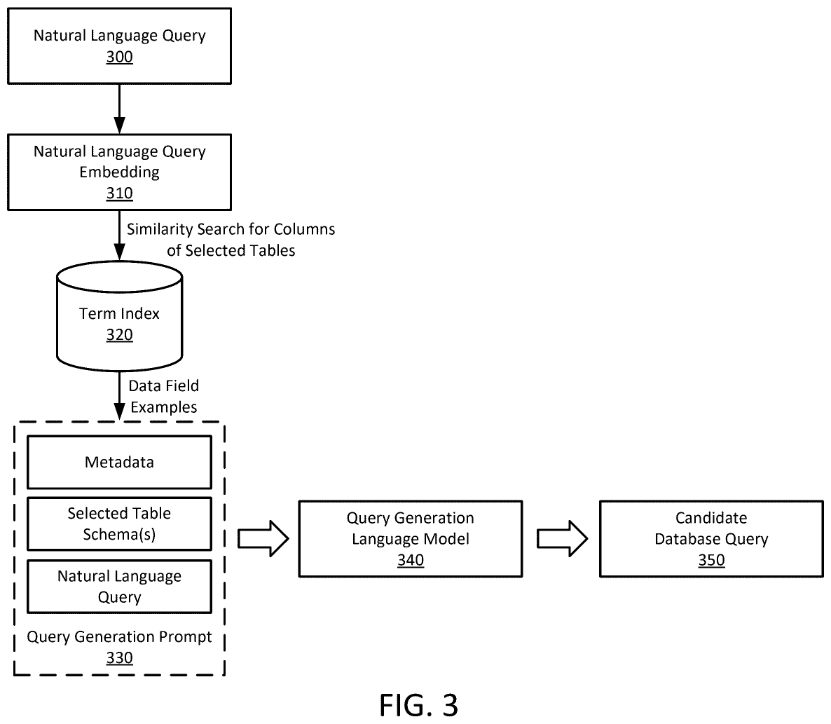

FIG. 3 shows an example dataflow for generating a candidate database query 350, according to one or more embodiments. The query processing module 110 may manage this dataflow in one or more embodiments to generate a plurality of candidate database queries. Generally, the query generation language model may receive a query generation prompt 330 that is processed to determine the candidate database query 350. In one embodiment, the query generation prompt 330 may include the natural language query in addition to information about the database, such as selected tables and related table schema. The query generation prompt may also include related metadata related to the selected tables.

In many cases, the table schema and typical database metadata may be insufficient to adequately generate effective candidate queries because different databases may store information about particular data fields in different ways. Although conceptually simple, generating a valid database query often requires knowledge of the formatting of column values, for instance, when using a WHERE clause. To generate a correct database query for the example natural language query “Which school is in California?” the query generation language model must know whether the state of California is represented as “CA”, “California”, or another variant thereof in the particular database being queried.

In some embodiments, the query generation prompt 330 is augmented with examples of data for particular data fields (e.g., columns) to increase the likelihood that the generated query correctly uses terminology or data entries consistent with the database. These may provide “few-shot” examples for the query generation language model 340 to use. In addition, the selected examples may be determined based on the natural language query 300. In the example in the previous paragraph, this may enable, for example, the examples for a column “state” are selected based on the natural language query, in this case to retrieve data field examples that are most similar to “California” in the natural language query. By including this information, the model can better infer the correct database query, resolving potential ambiguities related to data representation in the database. The query generation prompt 330 may thus be augmented with examples of the values of each column/data field as additional metadata.

To do so, a term index 320 may be constructed that can be effectively searched based on similarity to the language model query. In some embodiments, the term index 320 may be a vector index that stores example data values for particular data fields (columns) according to related vector representations. The term index 320 may particularly be generated for “string” data fields due to the wide potential variety of data entries. For each data field in a table, unique data field values are identified and used to populate the term index for that column. To do so, the data field values may be converted to a searchable vector, for example, by applying an embedding encoder to represent the data field values. The term index may thus provide an indexing of the unique entries of each data field and may be searched based on similarity to a querying embedding.

To obtain relevant data field examples for a natural language prompt, the natural language prompt (or individual portions thereof) may be encoded with an embedding model to determine a natural language query embedding 310 as an embedding representation of the natural language prompt (or individual portions/terms thereof). The embedding model may be a word or sentence embedding model, such as word2vec, and in some embodiments may be an embedding model based, e.g., on a general text embedding model (GTE). The natural language query embedding 310 may then be used to query similar data field values in the term index 320. This may be performed for each data field (column) of each table selected for the query generation prompt. By obtaining examples with the term index 320, nearest-neighbors of the natural language query embedding 310 in the data fields can be obtained for inclusion in the query generation prompt 330. For other data types (e.g., floating point numbers), data samples may be included and searched in the term index with other means, for example as a random sampling of the data field values in the database. The query generation prompt 330 may then be augmented with relevant data field examples and applied to the query generation language model 340 to generate a candidate database query 350.

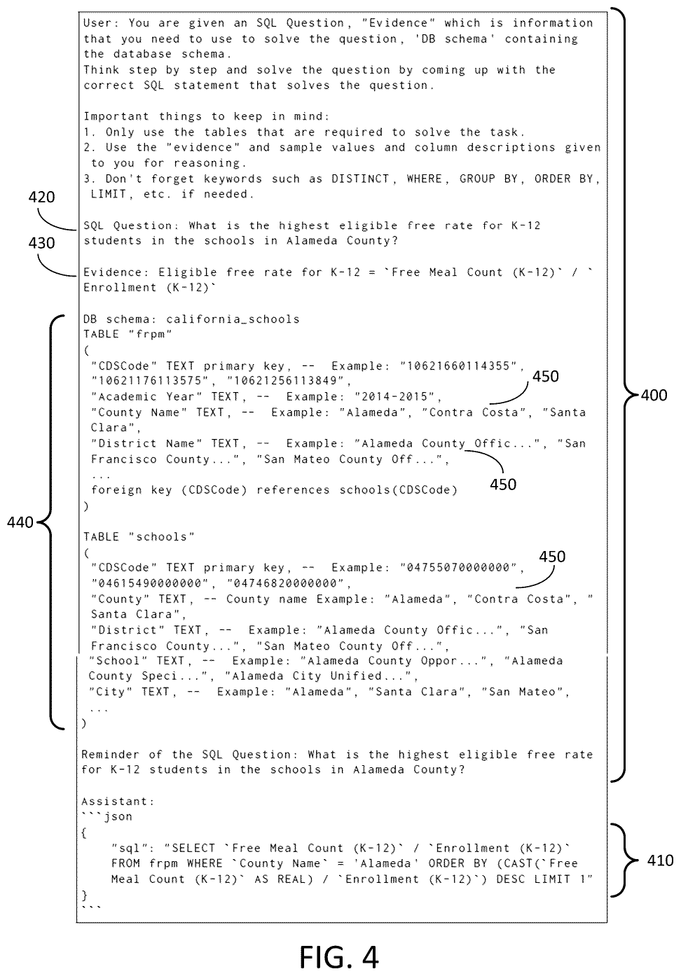

FIG. 4 shows an example query generation prompt 400 and related candidate database query 410, according to one or more embodiments. As discussed above, the query generation prompt 400 is the natural language input provided to the query generation language model and may be assembled from the various data discussed above. The query generation prompt in this example includes a natural language query 420 along with metadata 430 describing one of the requested terms (“Eligible free rate for K-12”) and schema 440 for the selected tables (“california_schools” and “schools”). In addition, the data fields of the schema are augmented with the data field examples 450 that may be retrieved based on the natural language query as discussed above. As shown in this example, by detecting data field examples based on the natural language query 420 relating to “Alameda County,” the data field examples 450 included in the query can effectively identify and provide the examples in the query generation prompt 400. As such, the query generation language model may generate a candidate database query 410 that effectively uses the field example (i.e., “WHERE ‘County Name’=‘Alameda’”).

### Database Query Evaluation

Returning to FIG. 2, a plurality of candidate database queries may be determined, as discussed above, by applying the query generation prompt to a query generation language model several times or by applying the query generation prompt to different query generation language models.

To aid in the evaluation of the candidate database queries, the query processing module 110 executes each of the candidate database queries against the database to determine 230 the associated query results. As such, rather than evaluating the generated database queries alone, the database queries may be evaluated in combination with the results that the database queries generate when executed. As such, in one embodiment, the query evaluation language model may receive a query evaluation prompt that includes the candidate database queries in addition to the respective query results. The candidate database queries and associated results are evaluated 250 by the query evaluation language model and the resulting evaluation may be selected 260 as a response to the natural language query.

In some embodiments, the process may stop based on whether the candidate database queries and/or the query results match. For example, the query results may be compared to determine whether the query results for the candidate database queries provide the same output when executed against the database. When the query results are not an empty set and otherwise executed correctly, it may suggest that, even if the candidate database queries are different, they may equivalently respond to the natural language query. As such, when the candidate database queries and/or associated query results match, a candidate database query is selected as a response to the natural language query without applying the query evaluation model. Stated another way, in one or more embodiments the query evaluation is applied selectively when the query results do not match for the candidate database queries.

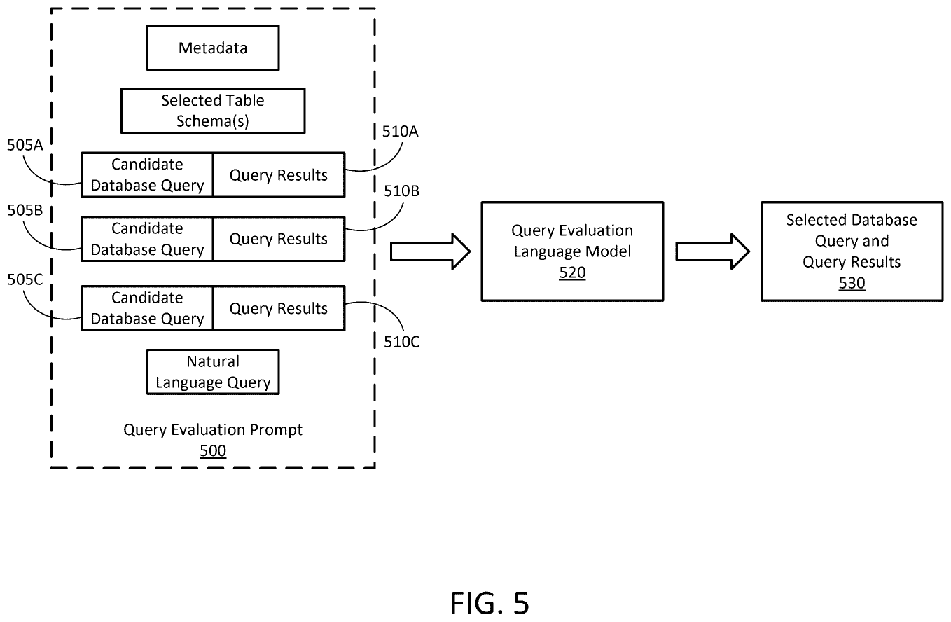

FIG. 5 shows an example dataflow for evaluating the candidate database queries, according to one or more embodiments. In this example, the query evaluation prompt assembled by the query processing module includes the natural language prompt, selected table(s) and related schemas, metadata (which may include the data field examples discussed above) in addition to one or more candidate database queries and associated query results (which may include any related error codes). By including the query results in the prompt, the query evaluation language model has additional context for evaluating the candidate database query, and particularly to do so comparatively across candidate database queries.

For example, if the query asks to find the average employee salary grouped by department, and a generated SQL query returns a single column of average salary without the grouping column, then the query evaluation language model should be able to identify the discrepancy and rule out the generated query.

In one embodiment, the query evaluation prompt evaluates an individual candidate database query with each query evaluation prompt. In this embodiment, the query evaluation language model may generate a value between zero and 1 by scoring the query evaluation prompt with the language model and an output logit to zero and one. The various candidate database queries may then each be evaluated and ranked accordingly and the highest-scoring candidate database query returned as the selected database query for the natural language query.

In additional embodiments, the query evaluation language model may evaluate multiple candidate data base queries with a single query evaluation prompt 500 as shown in FIG. 5. By including multiple candidate database queries, the evaluation model may jointly reason over multiple samples and account for subtle nuances that may make one query correct compared to another. In the example of FIG. 5, the query evaluation prompt 500 is constructed with candidate database queries 505A-C and associated query results 510A-C along with the natural language query, selected table schemas, and related metadata (which may include the augmented field examples based on the natural language query). The query evaluation prompt 500 is provided to the query evaluation language model 520 to obtain an output selecting the candidate database query that best corresponds to the natural language query. As such, the query evaluation language model 520 may be trained to perform an N-wise comparison of the number of input candidate database queries. In some embodiments, the output of the query evaluation language model 520 is an index corresponding to the preferred the candidate database query 505 in the query evaluation prompt 500. By providing multiple generated database queries along with the query results, the query evaluation language model 520 may learn to discern the correct (or “best”) response from the candidate database queries 505 in the prompt. By including the query results 510, the language model may also learn to compare the requested results in the natural language query with the query results and discern when differences between responses may fail to match the natural language query.

In some cases, excess candidate database queries and query results in one query evaluation prompt may prevent the query evaluation language model from maintaining the appropriate context data and may inhibit effective evaluation between the candidate database queries. As such, in some embodiments, the query evaluation prompt includes fewer candidate database queries (e.g., for N-wise comparisons) than the number of total generated candidate database queries (and associated query results). For example, the query evaluation prompt may be configured for a pairwise comparison between two candidate database queries while the total number of generated database queries may be higher (e.g., 4).

In these circumstances, multiple query evaluation prompts may be constructed to perform comparisons between the candidate database queries 505 in which each evaluation by the query evaluation language model 520 generates a selected database query and results 530 for the set of input candidate database queries. By determining the selected database queries for different input sets, an overall preferred database query may be selected. For example, the total set of candidate database queries may be evaluated round-robin, as a “tournament” or with a sliding window to compare subsets of candidate database queries and remove database queries that are dispreferred.

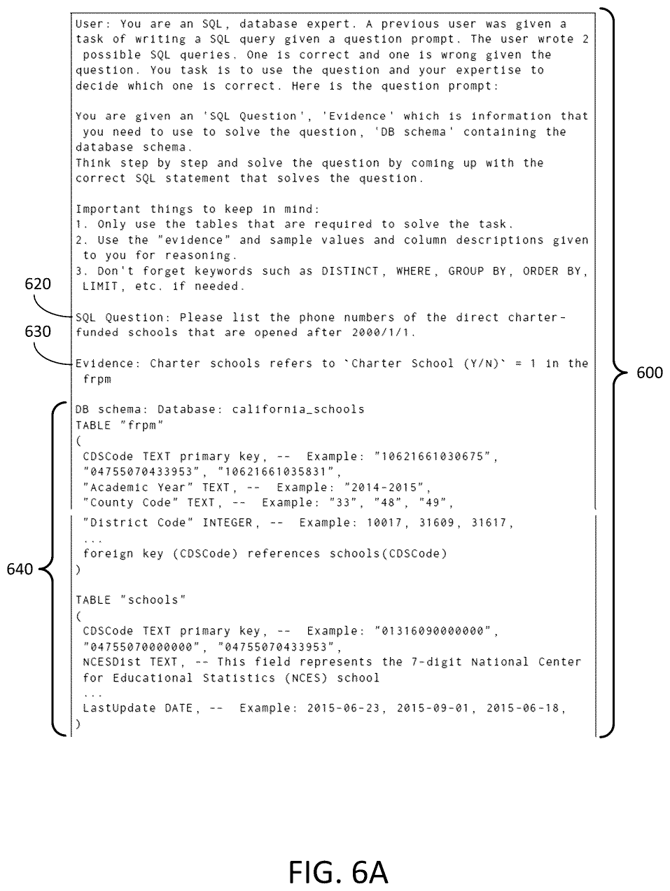

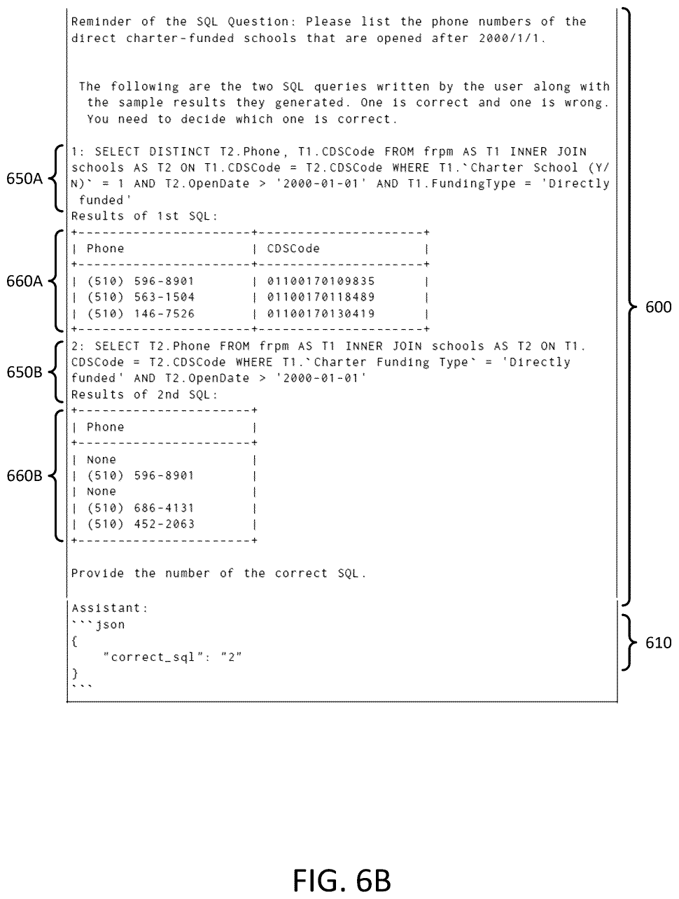

FIGS. 6A-B shows an example query evaluation prompt 600 and associated response 610 for candidate database query evaluation by a language model, according to one or more embodiments. The example query evaluation prompt 600 is one example of a query evaluation prompt that may be used for a pair-wise comparison between candidate database queries. The query evaluation prompt 600 includes various instructions for the language model and structures the relevant constituent data in the prompt for evaluation by the model. Particularly, the query evaluation prompt 600 may include data used for generating the database query, such as a natural language query 620, additional metadata 630 (and additional field examples as shown within the table schemas), and table schemas 640.

The query evaluation prompt 600 also includes the candidate database queries 650 and the associated query results 660 for the respective candidate database queries 650. The candidate database queries 650A-B and associated query results 660A-B may be labeled with an index or other unique identifier that may be used by the evaluation model to designate the preferred candidate database query. When constructing the query evaluation prompt 600 (for evaluation or in training), the query processing module 110 may randomize the ordering of the candidate database queries in the query evaluation prompt 600 to prevent the query processing module from improperly biasing its selection based on the position of the candidate database query. In the example of FIGS. 6A-B, the query evaluation prompt 600 designates an index “1” for a first candidate database query 650A and associated query results 660A and an index “2” for a second candidate database query 650A and associated query results 660B. By including the indices for the candidate database queries, the response 610 output from the query evaluation language model designates the preferred candidate database query with the corresponding index.

By generating and evaluating multiple candidate database queries along with corresponding query results, even though language models may be applied multiple times (i.e., to obtain the different multiple candidate queries and to evaluate them), this approach yields competitive performance of significantly smaller language models relatively to larger models. In addition, the number of candidate queries to generate may vary, enabling run-time scaling of computing resources that may not be possible with larger models.

### Language Model Training

The various language models may be trained to optimize performance of the language models with respect to their particular tasks. As also discussed above, the language model training may be performed by a model training module 120 according to various embodiments. The model training module 120 may also have access to various training data for training the respective language models. Particularly, the training data may include pairs of natural language queries and a labeled data query treated as the “correct” data query to be learned by the overall natural language query system. In various embodiments, the model training module 120 may train respective language models 130 by fine-tuning a general-purpose language model (or other pre-trained models) for each of the respective language models discussed above. The model training module 120 may train the language models 130 with respective training data and may use any suitable model training methodology as discussed below.

### Training Table Selection Language Model

In one embodiment, to train the table selection language model, the model training module 120 may generate a set of training data using pairs of natural language query and associated tables that are relevant to answering the query. In some embodiments, this training data is generated based on pairs of a natural language query and a database query for that natural language query. The database query specifies the particular tables/table schema used for responding to the query, such that the tables may be extracted and used to generate the appropriate table data for a training data pair of the natural language query and selected tables from the database. When generating prompts for the table selection language model, in some embodiments, the tables in the database may be supplemented with additional tables and table schemas, such that additional tables are available in the training data that may not be present in the use of these models. As noted above, the table selection language model may be trained with a training objective that emphasizes effective recall (e.g., to ensure that the output includes the correct tables from the database). In some embodiments, the training objective may still include a penalty for excess tables in the output to prevent the table selection language model from learning to simply reproducing all tables. As such, rather than an equivalent weighing, the training objective for training the table selection language model may more heavily penalize outputs that lack a desired table (relative to the training data) in the training data significantly more than an output that includes excess tables.

### Query Generation Language Model

To train the query generation language model, a query generation prompt is generated for the training data as discussed above. To account for the likelihood that the table selection model may include excess tables, the known tables for the data query may be supplemented in the training prompts to ensure the query generation language model also learns that not all provided tables may be relevant to or should necessarily be included in the result. To do so, the training data for the query generation language model may include some prompts with additional tables (e.g., by sampling 0 to n additional tables with weighted probabilities).

The query generation language model may generate the output as a sequence of output tokens in a sequence. This process may include stochastic elements, such that the query generation language model may generate different database queries with different probabilities. As such, when training the query generation language model, the training updates parameters of the model with respect to probability maximization of the labeled data output (the labeled “correct” database query). By including retrieval of contextual examples and adding excess tables to the training data, the query generation language model more effectively learns to discern superfluous tables and use relevant information from the schemas.

### Training Query Evaluation Language Model

To train the query evaluation language model, training data for the evaluation language prompt may be constructed with “correct” database queries and “incorrect” database queries, such that the language model query is trained to generate a “token” corresponding to the correct index in the prompt. While labeled training data may include a natural language query and corresponding database query, there may not be an obvious source of “incorrect” database queries to use in training the query evaluation language model. As one solution, embodiments may gather training data for the query evaluation language model based on the query generation language model. Particularly, the query generation language model may be applied to a natural language query having a known database query (e.g., as a training pair) and when the generated database query differs from the known database query, the different generated database query may be used in the training data for the query evaluation language model as the “incorrect” database query. In addition, these may be automatically collected during training of the query generation language model as the query generation language model generates database queries during training. This approach enables the “incorrect” database queries used to form prompts for the evaluation model to capture the particular ways that generative models may err in generating database queries for natural language queries.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for natural-language database queries, comprising:
one or more processors for executing instructions;
one or more computer-readable media containing instructions for execution by the one or more processors for:
receiving a natural language query for querying a database, the natural language query not being in a format compatible with a format for querying the database;
determining a plurality of candidate database queries by applying the natural language query to a query generation language model;
determining a plurality of candidate database query results, each corresponding to the plurality of candidate database queries, by querying the database with the respective candidate database query;
selecting a candidate database query by providing natural language query, the plurality of candidate database queries and associated sets of candidate database query results to a query evaluation language model; and
providing the selected candidate database query or the associated set of candidate database query results as a response to the natural language query.

2. The system of claim 1, wherein applying the natural language query to the query generation language model comprises prompting the query generation language model with the natural language query, a set of tables in the database, and metadata describing the tables of the database.

3. The system of claim 2, wherein the instructions are further executable for selecting the set of tables for the query generation language model as a subset of tables of the database by applying the natural language query to a table selection language model.

4. The system of claim 2, wherein the instructions are further executable for determining examples of data fields for at least one table of the set of tables by applying an embedding of the natural language model to a vector index.

5. The system of claim 1, wherein the natural language query evaluation model jointly evaluates two or more of the plurality of candidate database queries.

6. The system of claim 1, wherein selecting the candidate database query includes a plurality of pairwise comparisons of the plurality of candidate database queries by the query evaluation language model.

7. The system of claim 1, wherein the instructions are further executable for determining whether the plurality of candidate database query results are the same; and wherein selecting the candidate database query is performed selectively when the plurality of candidate database query results are not the same.

8. The system of claim 1, wherein training the query evaluation language model with training data is determined from training the query generation language model.

9. A method for natural-language database queries, comprising:
receiving a natural language query for querying a database, the natural language query not being in a format compatible with a format for querying the database;
determining a plurality of candidate database queries by applying the natural language query to a query generation language model;
determining a plurality of candidate database query results, each corresponding to the plurality of candidate database queries, by querying the database with the respective candidate database query;
selecting a candidate database query by providing natural language query, the plurality of candidate database queries and associated sets of candidate database query results to a query evaluation language model; and
providing the selected candidate database query or the associated set of candidate database query results as a response to the natural language query.

10. The method of claim 9, wherein applying the natural language query to the query generation language model comprises prompting the query generation language model with the natural language query, a set of tables in the database, and metadata describing the tables of the database.

11. The method of claim 10, further comprising selecting the set of tables for the query generation language model as a subset of tables of the database by applying the natural language query to a table selection language model.

12. The method of claim 10, further comprising determining examples of data fields for at least one table of the set of tables by applying an embedding of the natural language model to a vector index.

13. The method of claim 9, wherein the natural language query evaluation model jointly evaluates two or more of the plurality of candidate database queries.

14. The method of claim 9 wherein selecting the candidate database query includes a plurality of pairwise comparisons of the plurality of candidate database queries by the query evaluation language model.

15. The method of claim 9, further comprising determining whether the plurality of candidate database query results are the same; and wherein selecting the candidate database query is performed selectively when the plurality of candidate database query results are not the same.

16. The method of claim 9, wherein training the query evaluation language model with training data is determined from training the query generation language model.

17. A non-transitory computer-readable medium for natural-language database queries, the non-transitory computer-readable medium comprising instructions executable by a processor for:
receiving a natural language query for querying a database, the natural language query not being in a format compatible with a format for querying the database;
determining a plurality of candidate database queries by applying the natural language query to a query generation language model;
determining a plurality of candidate database query results each corresponding to the plurality of candidate database queries, by querying the database with the respective candidate database query;
selecting a candidate database query by providing natural language query, the plurality of candidate database queries and associated sets of candidate database query results to a query evaluation language model; and
providing the selected candidate database query or the associated set of candidate database query results as a response to the natural language query.

18. The non-transitory computer-readable medium of claim 17, wherein applying the natural language query to the query generation language model comprises prompting the query generation language model with the natural language query, a set of tables in the database, and metadata describing the tables of the database.

19. The non-transitory computer-readable medium of claim 18, wherein the instructions are further executable for selecting the set of tables for the query generation language model as a subset of tables of the database by applying the natural language query to a table selection language mode.

20. The non-transitory computer-readable medium of claim 18, wherein the instructions are further executable for determining examples of data fields for at least one table of the set of tables by applying an embedding of the natural language model to a vector index.
